(19) United States
(12) Patent Application Publication
(10) Pub. No.: US 2026/0048363 A1
(43) Pub. Date: Feb. 19, 2026

(54) ANTI-FOULING SEPARATION FILTER OR MEMBRANE FOR ENHANCED SEPARATION IN BIOMEDICAL, DAIRY, BEVERAGE, AND LIQUID PURIFICATION APPLICATIONS

(71) Applicant: ACULON, INC., SAN DIEGO, CA (US)

(72) Inventors: Eric L. Hanson, Carlsbad, CA (US); Eric L. Bruner, La Jolla, CA (US); MAJID MONJI, San Diego, CA (US); Qian HE, San Diego, CA (US)

(21) Appl. No.: 19/302,480

(22) Filed: Aug. 18, 2025

Related U.S. Application Data
(60) Provisional application No. 63/683,884, filed on Aug. 16, 2024.

(51) Int. Cl. B01D 69/02; B01D 69/12; B01D 71/40; B01D 71/80; C02F 1/44

(52) U.S. Cl. CPC B01D 69/02; B01D 69/1214; B01D 69/125; B01D 71/40; B01D 71/80; C02F 1/44; B01D 2315/08; B01D 2315/10; B01D 2325/04; B01D 2325/36

(57) ABSTRACT

Separation membranes and filters include (a) a porous substrate with a surface having reactive functional groups; (b) a polymerization initiator chemically bonded to at least one surface of the porous substrate via reaction with the reactive functional groups on the surface of the substrate; and (c) a polymeric coating layer prepared by a radical polymerization process from an aqueous monomer composition comprising at least one free radical polymerizable monomer having at least one hydrophilic functional group, such as a (meth)acrylamide group. The polymeric coating layer is chemically bonded to and propagated from the polymerization initiator, and the polymeric coating layer demonstrates hydrophilicity, such as a water contact angle less than 10 degrees. Also provided are methods of separating an aqueous fluid stream using the described filters or membranes.

### RELATED APPLICATIONS

The present application claims the benefit of U.S. Provisional Patent Application Ser. No. 63/683,884, titled “Anti-Fouling Filter or Membrane Coating for Enhanced Separation in Biomedical, Dairy, Beverage, and Liquid Filtration Applications”, filed Aug. 16, 2024, and incorporated by reference in its entirety.

The present application is related to International Patent Application Number PCT/US2022/049827, titled “Coated Substrates that Demonstrate Superhydrophilicity, Suitable for use as Medical Devices”, filed Nov. 14, 2022, which claims the benefit of U.S. Provisional Patent Application Ser. No. 63/281,016, titled “Coated Substrates that Demonstrate Superhydrophilicity, Suitable for use as Medical Devices”, filed Nov. 18, 2021, and U.S. Provisional Patent Application Ser. No. 63/281,280, titled “Coated Substrates that Demonstrate Superhydrophilicity, Suitable for use as Medical Devices”, filed Nov. 19, 2021, and incorporated by reference in their entireties.

### FIELD OF THE INVENTION

The present invention relates to anti-fouling separation filters and membranes for enhanced separation, such as water purification filters or membranes having thin coatings that demonstrate superhydrophilicity and fouling resistance. The present invention is further related to methods of separating an aqueous fluid stream.

### BACKGROUND OF THE INVENTION

Membranes and filters are commonly used in water purification at many steps in the process, from removal of macroscopic contaminants from a water stream to separation of ions from water in reverse osmosis. There is a significant problem associated with surface fouling of such separation units that has plagued the process since its inception. Fouling of a membrane or filter surface may be caused by microorganisms or suspended solids present in the water or even by adsorption of organic compounds present in the water. This can cause filter efficiency to drop substantially and increase the cost/energy to purify the water stream. This problem of fouling is even more difficult to control in water purification processes used in food and beverage manufacturing such as beer, wine or milk production, pharmaceutical compound manufacturing, dialysis and other industrial areas where there are significant concentrations of proteins and peptides in the water stream, as they tend to strongly adsorb to membrane surfaces and decrease efficiency.

One proposed method for preventing fouling includes making the membrane itself out of a hydrophilic polymer. See, for example, Chong-Jiang Lv et al., “Preparation of Superhydrophilic Poly(Acrylonitrile/Acrylic Acid) Electrospun Membrane and its Application in Oil/Water Separation”, Polymer, volume 258, 14 Oct. 2022, 125292. A drawback to the use of a hydrophilic polymer as the membrane itself is that its use is severely limited by the fluid streams that it may come in contact with; if it comes in contact with a compound that is incompatible, this may contaminate the membrane, damage the membrane or even render the membrane inoperable.

Changing the surface energy of a filter or membrane substrate is of great value in water purification. Depending on the needs and applications, substrate surfaces can be customized to exhibit hydrophilic, hydrophobic, oleophobic and oleophilic properties. Exceptionally hydrophilic surfaces are particularly desired in certain environments to prevent fouling of equipment by inorganic scale (e.g. calcium carbonate, barium sulfate, magnesium carbonate), proteins, peptides, microorganisms, and organic or inorganic suspended solids.

Scientifically, liquids with lower surface tensions (e.g., oil with surface tensions less than 30 mN/m) tend to wet solid surfaces (with specific surface energy) more than liquids with higher surface tensions (e.g., water with surface tension of 72.8 mN/m). Coated surfaces may be prepared to yield different contact angles for liquids with higher surface tensions compared to those with lower surface tensions.

The modification of substrate surfaces with superhydrophilic polymers has been proposed, using controlled radical polymerization (CRP) processes to dictate polymer architecture. Polymerization of (meth)acrylamide monomers that may provide such extreme hydrophilicity has historically been difficult to achieve via controlled radical polymerization processes such as ATRP, likely due to the exceptionally high rate of polymerization of these monomers as well as their chemical interaction with the copper-based catalysts typically used for such polymerization processes.

In addition, running these polymerizations in water adds another significant challenge due to the fact that ATRP initiators are usually activated alkyl halide compounds, which are highly prone to hydrolysis and rapidly lose their ability to control polymerization. When these polymerizations are conducted on surfaces in an aqueous medium, the ratio of initiating groups to water is many orders of magnitude in favor of water, making hydrolysis reactions far more likely than propagation of a polymer from an initiating site. Hence, the reported attempts of ATRP of (meth)acrylamide polymers in water are scarce, and surface-propagated polymerizations of them are absent from the literature to our knowledge.

Modifying the surfaces of substrates, including some modification methods that use CRP processes, tend to have drawbacks that make them unsuitable for many substrates because these processes typically employ solvents that are too aggressive, leading to degradation and/or swelling of a polymer substrate, or corrosion of a metal substrate caused by such solvents. For example, the most commonly used strategies for binding a polymerization initiator to a polymer surface use aggressive chemical attack to create functional groups (like hydroxyl, amine, etc.), followed by exposure to polar aprotic solvents such as diethyl ether, dichloromethane, etc., containing the initiator (for example, alpha-bromoisobutryl bromide) and a base catalyst such as triethylamine.

These methodologies are too aggressive to be used on most polymers, excepting highly fluorinated or crosslinked aromatic polymers such as PTFE, PFA, polyimide and PEEK. Commonly used polymers such as polyamide, pebax, acrylics, polyesters, polyolefins, PVC, and the like, are rapidly degraded by the aforementioned processes.

It would be desirable to provide anti-fouling membrane coating for enhanced separation in biomedical, dairy, beverage, and liquid filtration applications such as, for example, water purification membranes comprising commonly used substrates, demonstrating superhydrophilicity and anti-fouling, and methods of separating aqueous emulsions.

### SUMMARY OF THE INVENTION

One aspect of the present invention provides separation filters or membranes comprising:
(a) a porous substrate with a surface having reactive functional groups;
(b) a polymerization initiator, such as a controlled radical polymerization initiator, chemically bonded to at least one surface of the porous substrate via reaction with the reactive functional groups on the surface of the substrate; and
(c) a polymeric coating layer prepared by a radical polymerization process from a monomer composition comprising at least one free radical polymerizable monomer having at least one hydrophilic functional group. The polymeric coating layer is chemically bonded to and propagated from the polymerization initiator, and the polymeric coating layer demonstrates hydrophilicity.

The invention further provides separation filters or membranes, comprising:
(a) a porous substrate with a surface having reactive functional groups;
(b) a controlled radical polymerization initiator chemically bonded to at least one surface of the porous substrate via reaction with the reactive functional groups on the surface of the porous substrate; and
(c) a polymeric coating layer prepared by a controlled radical polymerization process from an aqueous monomer composition comprising at least 50 percent by weight, based on the total weight of monomers in the monomer composition, of at least one (meth)acrylamide monomer having at least one ionic functional group, and wherein the polymeric coating layer is chemically bonded to and propagated from the polymerization initiator (b). The polymeric coating layer demonstrates a water contact angle less than 10°, and retains a water contact angle of less than 10° after immersion in phosphate buffered aqueous saline solution at 22° C. for a period of 28 days.

The invention further provides methods of separating an aqueous fluid stream, comprising the steps of:
(i) contacting the aqueous fluid stream with a separation filter or membrane; and
(ii) allowing water in the fluid stream to permeate through the separation filter or membrane to yield an aqueous product stream, wherein the separation filter or membrane comprises:
(a) a porous substrate with a surface having reactive functional groups;
(b) a radical polymerization initiator chemically bonded to at least one surface of the porous substrate via reaction with the reactive functional groups on the surface of the porous substrate; and
(c) a polymeric coating layer prepared by a radical polymerization process from an aqueous monomer composition comprising at least one free radical polymerizable monomer having at least one hydrophilic functional group. The polymeric coating layer is chemically bonded to and propagated from the polymerization initiator (b) and demonstrates hydrophilicity.

These and other advantages of the present invention are described in the following detailed description of the invention.

### BRIEF DESCRIPTION OF THE DRAWINGS

FIG. 1 is a schematic sectional view of a cross-flow separation filter or membrane according to an embodiment of the present invention.

FIG. 2 is a schematic cross-sectional molecular scale view of a portion of a separation filter or membrane of the present invention.

FIG. 3 is a schematic sectional view of an end-flow separation filter or membrane according to an embodiment of the present invention.

FIG. 4 is a schematic sectional view of an end-flow separation filter or membrane according to another embodiment of the present invention.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various aspects and examples of the present invention as presented herein are each understood to be non-limiting with respect to the scope of the invention.

As used in the following description and claims, the following terms have the meanings indicated below:

The terms “on”, “appended to”, “affixed to”, “bonded to”, “adhered to”, or terms of like import means that the designated item, e.g., a coating, film or layer, is either directly connected to (in contact with) the object surface, or indirectly connected to the object surface, e.g., through one or more other coatings, films or layers.

As detailed herein, the present invention provides an anti-fouling membrane 10 with a polymeric membrane coating 16 on a substrate 12 thereof for enhanced separation applicable for use in biomedical, dairy, beverage, and liquid filtration applications. As detailed herein the membrane coating 16 significantly reduces fouling, extending the operational lifespan of membrane 10 used in filtration systems used in the processing of biomedical fluids, milk, wine, beverages, and other liquid products including water purification filtration. The coating 16 used in the separation membranes and filters 10 of the present invention inhibits the accumulation of organic and inorganic contaminants on membrane surfaces, ensuring consistent and reliable separation performance. The membrane coating 16 enhances separation efficiency, allowing for the membrane 10 to be utilized in the precise filtration and purification of complex liquid mixtures, including dairy products, fermented beverages, and various industrial liquids. As detailed below in connection with a water filtration membrane 10 according to one embodiment of the present invention, by improving selectivity and reducing permeation resistance, this coating 16 ensures high-quality separation of proteins, fats, and other constituents in milk, wine, and beverage processing.

The anti-fouling separation membranes and filters 10 of the present invention are universally applicable across a wide range of industries, including dairy, wine-making, beverage production, medical, and beyond, making it an ideal solution for diverse liquid filtration needs. The polymeric coating 16 is compatible with various types of substrates 12 of the membranes 10, designed to be effective in microfiltration, ultrafiltration, and nanofiltration processes across multiple liquid processing industries. The coating 16 reduces the need for frequent cleaning and maintenance, lowering operational costs and minimizing downtime in industrial filtration systems. The use of the coating 16 contributes to sustainability by reducing the environmental impact of fouling of the membrane 10, decreasing chemical usage, and extending life of the membrane 10. The coating 16 exhibits long-term durability and stability, maintaining its anti-fouling properties even under harsh processing conditions, such as varying temperatures, pH levels, and chemical exposures. Resistant to degradation, the coating 16 ensures consistent performance over extended operational periods, providing a reliable solution for continuous liquid separation processes.

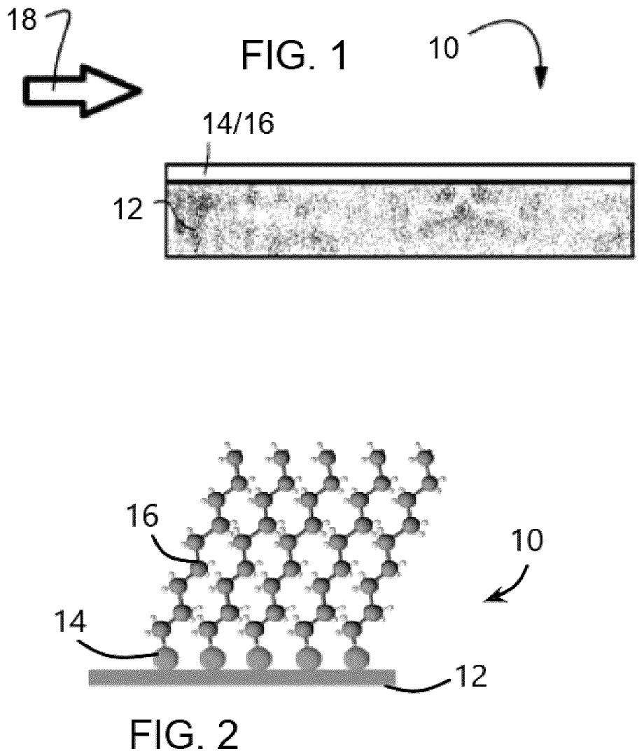

The separation membranes and filters 10 will be described in accordance with a water filtration filter 10, but are applicable to biomedical, dairy, beverage, and other liquid filtration applications. The separation filters and membranes 10 of the present invention, as shown in FIGS. 1 to 4, comprise (a) a porous substrate 12 with a surface having reactive functional groups. The porous substrate 12 is typically in the form of a sheet having opposing surfaces. The substrate 12 may be a woven mesh, a nonwoven mesh, or knit as a mesh; or perforated. The substrate 12 may be inherently porous and/or may be perforated with ordered or random microarrays of microchannels. “Microchannels” are understood to be micro-dimensional fluidic channels (e. g., having average diameters on a micron or nanometer scale). In microtechnology, a microchannel is understood to have a hydraulic diameter below 1 millimeter, such as below 500 microns, or below 100 microns, or below 1 micron. In particular examples of the present invention, the porous substrate 12 demonstrates average pore sizes greater than 100 nm, or even greater than 300 nm. Alternatively, the porous substrate 12 may demonstrate an average pore size of 0.05 to 100 nm, which is useful for reverse osmosis, ultrafiltration, and nanofiltration applications. Typically, the average pore size of the substrate 12 is less than 1 mm.

The substrate 12 may be flat with a planar or corrugated surface independently on either or both opposing surfaces, pleated, convex or concave with respect to fluid flow, or in any other configuration known in the filtration art. It may be rigid or flexible.

Substrates 12 suitable for use in the preparation of the filters and membranes 10 of the present invention can include a silicate such as glass including fiberglass, ceramic, a metal selected from at least one of aluminum, copper, stainless steel, a metal oxide, nitinol, palladium, nickel, tantalum and titanium; or a polymer selected from at least one of a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

Filters typically remove suspended particulate solids or immiscible liquids from a fluid stream. Membranes may remove suspended particulate solids or immiscible liquids from a fluid stream, and also miscible liquids or dissolved compounds from the fluid stream by chemisorption, physisorption, and the like. Reverse osmosis, ultrafiltration, and nanofiltration membranes, inter alia, are suitable for use as a separation filter or membrane of the present invention.

As noted above, the substrate 12 has reactive functional groups on the surface. Suitable functional groups include active hydrogen groups such as hydroxyl, amino, amido, thiol, carboxylic acid, and the like. The reactive functional groups allow for chemical bonding between the substrate 12 and a polymerization initiator 14, as shown in FIG. 2.

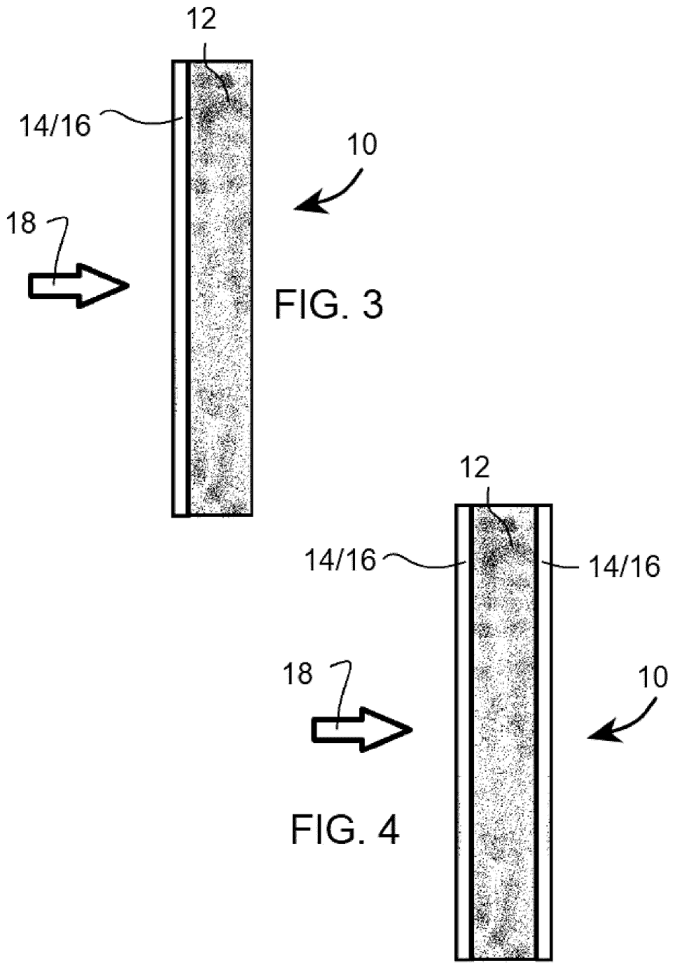

The thickness of the substrate 12 depends on the context in which the filter or membrane 10 is to be used; art recognized thicknesses are suitable. The polymeric coating layer 16 may be formed on at least one surface of the substrate 12, as shown in FIGS. 1 and 3, up to all of the surfaces of the substrate 12, such as both of two opposing surfaces, as shown in FIG. 4.

Before bonding the polymerization initiator 14 to the substrate 12, the surface of the substrate 12 may be modified by any of a variety of well-known techniques such as corona or argon plasma discharge, or chemical etching (particularly using a NaOH or KOH solution), to generate the reactive functional groups, such as hydroxyl, amido, thiol, carboxylic acid, epoxy and/or amine functional groups on the substrate surface.

Alternatively, an activated layer comprising metal may be applied to the substrate 12 to form the reactive functional groups on the substrate 12. When this method is used, the activated layer may comprise one or more of Ti, Cr, Al, Ta, Nb, Ni, silver oxide, gold oxide, palladium oxide, platinum oxide, rhodium oxide, iridium oxide, tantalum oxide, aluminum oxide, copper oxide, titanium oxide, iron oxide, zirconium oxide, silicon oxide and chromium oxide.

The separation filters and membranes 10 of the present invention further comprise (b) a polymerization initiator 14 chemically bonded to at least one surface of the substrate 12 via reaction with the reactive functional groups on the surface of the substrate. The polymerization initiator 14 may be bonded to the substrate 12 using conventional techniques, including physical vapor deposition (PVD) or chemical vapor deposition (CVD), to ensure a thin layer of molecular dimensions.

Any initiators known in the art for radical polymerization processes, in particular, living (i.e., controlled radical) polymerization processes are suitable, provided they may be chemically bonded to the substrate surface by reaction with the reactive functional groups. Organosilicon compounds may serve as an initiator. Suitable organosilicon compounds include alkoxysilane functional compounds such as (3-trimethoxysilyl)propyl-2-bromo-2-methylpropionate. Also suitable are organosilicon-containing compounds with ethylenically unsaturated groups, such as (3-trimethoxysilyl)propyl (meth)acrylate, and (3-trimethoxysilyl)propyl (meth)acrylamide. Also useful are organophosphorus acids chemically bonded to the substrate surface, wherein the organo portion of the organophosphorus acid contains an initiator moiety such as a halide group (e. g., bromide, chloride, or iodide). Other halide-containing compounds including benzyl halides, 2-halo-propionitriles, alkyl or acyl halide compounds, such as isobutyryl halides, α-halooisobutyryl halide (e. g. α-bromoisobutyryl bromide), are also suitable. Azo-initiators such as azobisbutyronitrile (AlBN). 1,1′-azobis(cyclohexanecarbonitrile), and 4,4-azobis (4-cyanopentanoic acid), and K₂S₂O₈, as used in addition-fragmentation chain transfer (RAFT) polymerization processes may also be employed.

The separation filters and membranes 10 of the present invention further comprise (c) a hydrophilic polymeric coating layer 16. The polymeric coating layer 16 is chemically bonded to, and propagated from, the polymerization initiator 14.

The polymeric coating layer 16 may be prepared from an aqueous monomer composition comprising at least one free radical polymerizable monomer having at least one hydrophilic functional group. Any other monomer capable of free-radical polymerization may also be used in the aqueous monomer composition. Examples of particularly suitable monomers include hydrophilic styrene functional monomers, acrylonitrile, (meth)acrylamide functional monomers, 4-vinylpyridine, sodium 4-vinylbenzenesulfonate, and monomers that are quaternized with a halide (e. g., chloride or fluoride) or have functional groups that are capable of being quaternized with a halide after polymerization. Other suitable monomers include dienes, alkylvinyl monomers or allyl ethers.

In a particular example, the polymeric coating layer 16 may be prepared from an aqueous monomer composition comprising at least 10 percent by weight, such as at least 50 percent by weight, based on the total weight of monomers in the monomer composition, of at least one (meth)acrylamide monomer having at least one ionic functional group. For example, the polymeric coating layer 16 may be formed from an aqueous monomer composition comprising at least one of a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, chloride, [3-(acryloylamino)propyl]trimethylammonium N,N′-dimethyl(meth)acrylamide and salts thereof, and 3-[(3-(meth)acrylamidopropyl)dimethylammonio]propanoate. The polymeric coating layer 16 may comprise a homopolymer of any of the above monomers, or may comprise a copolymer, such as a block copolymer, of two or more of the above monomers, designed to provide both hydrophilic and additional antifouling and separation properties.

The polymeric coating layer 16 is typically prepared via a radical polymerization process, such as a controlled radical polymerization (CRP) or “living” process; i. e., a chain-growth polymerization that propagates with essentially no chain transfer and essentially no chain termination. The molecular weight of a polymer prepared by CRP can be controlled by the stoichiometry of the reactants, i.e., the initial concentration of monomer(s) and initiator(s). In addition, CRP also provides polymers having characteristics including, for example, narrow molecular weight distributions, e. g., PDI values less than 2.5, and well-defined polymer chain architecture, e. g., block copolymers and alternating copolymers. As used herein, the term “controlled radical polymerization” and related terms such as “controlled radical polymerization process” includes, but is not limited to, atom transfer radical polymerization (ATRP), single electron transfer polymerization (SETP), reversible addition-fragmentation chain transfer (RAFT), and nitroxide-mediated polymerization (NMP).

In forming the separation filters and membranes 10 of the present invention, the surface of the substrate 12 is first contacted with initiator molecules to chemically bond the initiator 14 to the substrate 12 via reaction with the reactive functional groups on the surface of the substrate 12 to form an activated surface. The activated surface is then contacted with the monomer composition described above and a CRP catalyst, and polymerized under CRP conditions in an aqueous medium to form a layer or film of (meth)acrylamide-containing polymer. The membranes or filters 10 may be coated after they are manufactured, or the substrate 12 used to prepare the filter or membrane 10 may be coated in-line in a roll-to-roll process prior to forming the substrate 12 into a filter or membrane 10. The polymeric coating layer 16 is formed on surfaces of the substrate 12 that will come in contact with an aqueous stream.

In an example using ATRP, the substrate 12 surface having reactive functional groups is contacted with a compound containing in a terminal portion a functional group reactive with the reactive functional groups on the substrate 12 surface, and in a second terminal portion, an initiator for ATRP. A self-assembled monolayer (SAM) is formed from the compound bonded to the substrate surface, with the initiator 14 outwardly from the substrate surface. The SAM is contacted with an aqueous mixture comprising the monomer composition and an ATRP catalyst, and the monomer composition is polymerized to form a layer of (meth)acrylamide-containing polymer on the substrate 12 surface, chemically bonded to and propagated from the polymerization initiator 14.

The ATRP polymerization catalyst is typically a transition metal compound, which participates in a reversible redox cycle with the initiator; and a ligand, which coordinates with the transition metal compound. The ATRP process is described in further detail in International Patent Publication No. WO 98/40415 and U.S. Pat. Nos. 5,807,937, 5,763,548 and 5,789,487 which are incorporated herein by reference.

Catalysts that may be used in the ATRP preparation include any transition metal compound. It is preferred that the transition metal compound not form direct carbon-metal bonds with the polymer chain. Transition metal catalysts useful in the present invention may be represented by the following general formula:

Mⁿ⁺Xₙ

wherein M is the transition metal, n is the formal charge on the transition metal having a value of from 0 to 7, and X is a counterion or covalently bonded component. Examples of the transition metal M include, but are not limited to, Cu, Fe, Au, Ag, Hg, Pd, Pt, Co, Mn, Ru, Mo, Nb and Zn. Examples of X include, but are not limited to, halide, hydroxy, oxygen, C₁-C₆ alkoxy, cyano, cyanato, thiocyanato and azido. A preferred transition metal is Cu(I) and X is preferably halide, e.g., chloride. Accordingly, a preferred class of transition metal catalyst is the copper halides, e.g., Cu(I)Cl. It is also preferred that the transition metal catalyst contain a small amount, e.g., 1 mole percent, of a redox conjugate, for example, Cu(II)Cl₂, when Cu(I)Cl is used. Additional catalyst useful in preparing the pigment dispersant are described in U.S. Pat. No. 5,807,937 at column 18, lines 29 through 56 which patent is incorporated herein by reference in its entirety. Redox conjugates are described in further detail in U.S. Pat. No. 5,807,937 at column 11, line 1 through column 13, line 38 which patent is incorporated herein by reference in its entirety.

Ligands that may be used in ATRP for preparation of the polymerization catalyst include compounds having one or more nitrogen, oxygen, phosphorus and/or sulfur atoms, which can coordinate to the transition metal catalyst compound, e. g., through sigma and/or pi bonds. Classes of useful ligands include tertiary aliphatic amines, unsubstituted and substituted pyridines and bipyridines; porphyrins; cryptands; crown ethers; e.g., 18-crown-6; polyamines, e.g., ethylenediamine; glycols, e.g., alkylene glycols, such as ethylene glycol; carbon monoxide; and coordinating monomers, e.g., styrene, acrylonitrile and hydroxyalkyl (meth)acrylates. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

As used herein and in the claims, the term “(meth)acrylate” and similar terms refer to acrylates, methacrylates and mixtures of acrylates and methacrylates; similarly for (meth)acrylamide. A preferred class of ligands are the substituted bipyridines, e.g., 4,4′-dialkyl-bipyridyls. Additional ligands that may be used in preparing pigment dispersant are described in U.S. Pat. No. 5,807,937 at column 18, line 57 through column 21, line 43 which patent is incorporated herein by reference in its entirety.

The reducing agent may be any reducing agent capable of reducing the transition metal catalyst from a higher oxidation state to a lower oxidation state, thereby reforming the catalyst activator state. Such reducing agents include, for example, SO₂, sulfites, bisulfites, thiosulfites, mercaptans, hydroxylamines, hydrazine (N₂H₄), phenylhydrazine (Ph-NHNH₂), hydrazones, hydroquinone, food preservatives, flavonoids, beta carotene, vitamin A, α-tocopherols, vitamin E, propyl gallate, octyl gallate, BHA, BHT, propionic acids, ascorbic acid, sorbates, reducing sugars, sugars comprising an aldehyde group glucose, lactose, fructose, dextrose, potassium tartrate, nitriles, nitrites, dextrin, aldehydes, glycine, and transition metal salts. Water-soluble reducing agents are particularly suitable.

The above-mentioned ingredients are typically dissolved or suspended in an aqueous medium which may include in minor portions a diluent such as an organic solvent, for example, acetone or methanol. Also, solvents such as those containing oligo ethylene oxide and propylene oxide groups, such as diethylene glycol, diethylene glycol monomethyl ether and tripropylene glycol monomethyl ether may be used in minor portions. Such solvents may boost the activity of the catalyst. The concentration of the radically polymerizable monomers is typically from 5 to 70 percent by weight based on total weight of solution. The molar ratio of catalyst to monomer ranges from 1:5 to 1:500, such as 1:20 to 1:100; the molar ratio of ligand to catalyst ranges from 1:2 to 1:100, such as 1:2 to 1:5. The molar ratio of reducing agent to catalyst is from 1:0.1 to 10 such as 1:0.5 to 2.

The aqueous solution of the radically polymerizable monomer composition can be applied to the initiator-coated substrate (i. e., the activated surface) by conventional means such as dipping, rolling, spraying, printing, stamping or wiping to ensure uniform coating of the substrate surface. The solution may be applied to the entire substrate surface or over a portion thereof, such as in a predetermined pattern using a mask. Often, the solution is applied to the entire substrate surface (e. g., both opposing surfaces as shown in FIG. 4), particularly when the solution is applied by immersion, but it may be applied using any of the methods discussed above. The formation of the ATRP film or coating can occur at temperatures in the range of −10 to 150° C. and at pressures of 1-100 atmospheres, usually at ambient temperature and pressure. By “ambient” conditions is meant without the application of heat or other energy; for example, when a curable composition undergoes a thermosetting reaction without baking in an oven, use of forced air, irradiation, or the like to prompt the reaction, the reaction is said to occur under ambient conditions. Usually, ambient temperature ranges from 60 to 90° F. (15.6 to 32.2° C.), such as a typical room temperature, 72° F. (22.2° C.). The time for conducting the ATRP can vary depending on the thickness of the film desired. The polymeric coating layer 16 typically has a thickness greater than 50 nm and less than 2.5 microns, such as less than 2 microns, or less than 1 micron, or even less than 100 nm. Such thick coating layers of aqueous CRP-generated (meth)acrylamide polymer coating layers have not been achieved previously; the thickness of the coating contributes to lubricity. The thickness of the film can be monitored by Quartz Crystal Microgravometric (QCM) measurement and the time for the ATRP is typically from 30 to 600 minutes. After ATRP, the coated substrate is removed from any remaining solution by rinsing with a polar solvent and drying the coated substrate.

When the activated surface of the initiator-coated substrate 12 is exposed to the aqueous solution of the radically polymerizable monomer composition and subjected to ATRP conditions, the monomers contained therein form covalent bonds with each other and with the initiator groups that are bonded to the surface of the substrate 12. As mentioned above, the resultant coating 16 or film is relatively thick (compared to typical surface ATRP processes) with strong adhesion to the substrate. The resulting polymer forming coating 16 has a low polydispersity index because chain transfer reactions are minimized. Lower polydispersity indices enable the molecular weight of the polymer forming coating 16 to be controlled and optimized for the particular application intended.

The process may further include subjecting the coated substrate 12 to heat or UV radiation to effect curing of any reactive functional groups on the polymers of the polymeric coating layer 16. Such curing may further ensure a robust and durable polymeric coating layer 16.

The term “cure”, “cured” or similar terms, as used in connection with a cured or curable composition, e.g., a “cured composition” of some specific description, means that at least a portion of any polymerizable and/or crosslinkable components that form the curable composition is polymerized and/or crosslinked. Additionally, curing of a composition refers to subjecting said composition to curing conditions such as heating or exposure to actinic radiation, depending on the chemistry, leading to the reaction of any reactive functional groups in the composition. The term “at least partially cured” means subjecting the composition to curing conditions, wherein reaction of at least a portion of the reactive groups of the composition occurs. The composition can be subjected to curing conditions as necessary depending on the composition of the coating layers, such that a substantially complete cure is attained and wherein further curing results in no significant further improvement in physical properties, such as hardness. The polymeric coating layers formed on the substrate surface do not detrimentally block the pores of the membranes.

The resultant coated membranes and filters 10 are hydrophilic, even superhydrophilic, demonstrating lubricity, and the polymeric coating layers 16 serve as easy clean coatings and antifouling coatings 16. The coating layer 16 typically demonstrates a water contact angle less than 10°, typically less than 5°, and retains a contact angle of less than 10° after immersion in phosphate buffered (approximate pH of 7.4) aqueous saline solution at 22° C. for a period of 28 days, often greater than 28 days. Additionally, the coating layer 16 will not lose its hydrophilic or lubricious properties under these conditions

By “superhydrophilicity” is meant a high degree of hydrophilicity, or attraction to water; in superhydrophilic materials, the contact angle of water is less than 10°, often less than 5°, even equal to 0°.

The filters and membranes 10 may be housed in filter assemblies. Any suitable filter assembly known in the art may be used, with the coated substrates 12 described above used as the separation media. The filter or membrane 10 housed within the filter assembly may be in any practical configuration; for example, it may be configured to maximize surface area contact with the fluid being treated, such as by pleating. Multiple filters and/or membranes 10 may be arranged in series in a separation system.

The separation system may further comprise additional oleophobic and/or hydrophilic filters and/or membranes 10. Typically, the different filters or membranes 10 are arranged in an alternating configuration. The system may also include a conventional particulate filter to remove solid particulates from a fluid feed stream before contacting the coated membrane(s) 10.

The present invention is further drawn to a method of separating an aqueous fluid stream. The fluid stream may comprise one or more of a suspension of particulate solids and/or immiscible liquids in water, an aqueous solution, and an aqueous emulsion. By “aqueous emulsion” is meant an emulsion having a continuous aqueous phase, with a dispersed liquid phase comprising compounds that are at least partially immiscible with water, such as organic compounds including, inter alia, oil and other hydrocarbons, proteins, peptides, biological compounds, polysiloxanes, and the like. The method comprises:
(i) contacting the aqueous fluid stream with any of the separation filters or membranes 10 above; and
(ii) allowing water in the fluid stream to permeate through the separation filter or membrane 10 to yield an aqueous product stream, wherein the separation filter or membrane 10 comprises, as described above:
   (a) a porous substrate 12 with a surface having reactive functional groups;
   (b) a radical polymerization initiator 14 chemically bonded to at least one surface of the porous substrate 12 via reaction with the reactive functional groups on the surface of the porous substrate 12; and
   (c) a polymeric coating layer 16 prepared by a radical polymerization process from an aqueous monomer composition comprising at least one free radical polymerizable monomer having at least one hydrophilic functional group; and wherein the polymeric coating layer 16 is chemically bonded to and propagated from the polymerization initiator (b); and wherein the polymeric coating layer 16 demonstrates hydrophilicity. The aqueous monomer composition may comprise any of the monomers disclosed above.

In step (i) of the method of the present invention, the fluid stream 18 is contacted with the separation filter or membrane 10, typically by passing the stream 18 through the filter or membrane 10. This is known as an end-flow configuration, and is shown in FIGS. 3 and 4. Alternatively, the stream 18 may flow parallel to the filter or membrane 10 in a cross-flow configuration, as shown in FIG. 1. Pumping or gravity feed may be employed. In steps (ii) and (iii), using an aqueous stream as an example, as the aqueous fluid stream 18 contacts the filter or membrane 10, water permeates through the separation filter or membrane 10 to yield an aqueous product stream. In dialysis, blood permeates through a separation membrane to yield purified blood.

Exemplary aqueous fluid streams 18 that may be treated include blood (the membranes 10 are suitable for use in dialysis), wastewater streams from food or beverage (such as milk, beer, or wine) production, municipal sewage, pharmaceutical production process water, or poultry processing plant effluent. Examples of contaminants that may be present in the waste stream to be treated include grease, fats such as animal fats; proteins; peptides, polysiloxanes; pharmaceutical production products and byproducts; biological compounds such as blood products; biological compounds, microorganisms, toxins; heavy metals; dyes; lubricants; and pesticides.

An organic compound-rich, such as a protein-rich retentate is formed within the system and may be recirculated to the feed stream 18 or discarded. The retentate may further comprise other organic materials that are repelled by the filters and/or membranes 10 in the separation system. The aqueous product stream typically comprises less than 3 percent by weight organic compounds, based on the total weight of the aqueous product stream.

The membrane coating 16 discussed above significantly reduces fouling, extending the operational lifespan of filtration systems including the coated membranes 10 applicable for use in the processing of biomedical, milk, wine, beverages, and other liquid products.

Whereas particular embodiments of this invention have been described above for purposes of illustration, it will be evident to those skilled in the art that numerous variations of the details of the present invention may be made without departing from the scope of the invention as defined in the appended claims and equivalents thereto.

What is claimed is:

1. A separation filter or membrane comprising:
(a) a porous substrate with a surface having reactive functional groups;
(b) a polymerization initiator chemically bonded to at least one surface of the porous substrate via reaction with the reactive functional groups on the surface of the porous substrate; and
(c) a polymeric coating layer prepared by a radical polymerization process from a monomer composition comprising at least one free radical polymerizable monomer having at least one hydrophilic functional group, and wherein the polymeric coating layer is chemically bonded to and propagated from the polymerization initiator (b); and
wherein the polymeric coating layer demonstrates hydrophilicity.

2. The separation filter or membrane of claim 1, wherein the porous substrate (a) has two opposing surfaces and comprises a metal mesh, a perforated metal sheet, a ceramic mesh, a perforated ceramic sheet, a glass mesh, a perforated glass sheet, an organic or inorganic polymer mesh or a perforated organic or inorganic polymer sheet.

3. The separation filter or membrane of claim 2, wherein the porous substrate (a) comprises a metal selected from at least one of aluminum, copper, stainless steel, a metal oxide, nitinol, palladium, nickel, tantalum, silicon oxide and titanium; or polymer selected from at least one of a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

4. The separation filter or membrane of claim 1, wherein the porous substrate (a) demonstrates an average pore size of 0.05 to 100 nm.

5. The separation filter or membrane of claim 1, wherein the porous substrate (a) demonstrates an average pore size greater than 100 nm.

6. The separation filter or membrane of claim 1, wherein the surface of the porous substrate (a) comprises hydroxyl, amido, thiol, carboxylic acid, epoxy and/or amine functional groups.

7. The separation filter or membrane of claim 1, wherein the polymerization initiator (b) comprises a halogen-containing compound.

8. The separation filter or membrane of claim 1, wherein the polymerization initiator (b) is a controlled radical polymerization initiator comprising an isobutyryl halide, a benzyl halide, a 2-halo-propionitrile, an α-haloisobutyryl halide, azobisbutyronitrile (AlBN), 1,1′-azobis(cyclohexanecarbonitrile), 4,4-azobis (4-cyanopentanoic acid), or potassium persulfate (K₂S₂O₈).

9. The separation filter or membrane of claim 1, wherein the polymeric coating layer (c) is formed from an aqueous monomer composition comprising at least one of a styrene functional monomer, acrylonitrile, (meth)acrylamide functional monomer, 4-vinylpyridine, sodium 4-vinylbenzenesulfonate, and a monomer that is quaternized with a halide or has functional groups that are capable of being quaternized with a halide after polymerization.

10. The separation filter or membrane of claim 1, wherein the polymeric coating layer (c) is formed from an aqueous monomer composition comprising at least one of a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide and salts thereof, and 3-[(3-(meth)acrylamidopropyl)dimethylammonio]propanoate.

11. The separation filter or membrane of claim 1, wherein the polymeric coating layer (c) comprises a homopolymer of a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide or salts thereof, or 3-[(3-(meth)acrylamidopropyl)dimethylammonio]propanoate.

12. The separation filter or membrane of claim 1, wherein the polymeric coating layer (c) comprises a block copolymer.

13. The separation filter or membrane of claim 1, wherein the polymeric coating layer (c) has a thickness greater than 10 nm and less than 5 microns.

14. The separation filter or membrane of claim 1, wherein the membrane demonstrates antifouling by a contaminant comprising grease, fat, protein, peptides, polysiloxanes, biological compounds, microorganisms, toxins, heavy metals, dyes, lubricants, pesticides and/or a pharmaceutical production product or by-product.

15. A separation filter or membrane comprising:
(a) a porous substrate with a surface having reactive functional groups;
(b) a controlled radical polymerization initiator chemically bonded to at least one surface of the porous substrate via reaction with the reactive functional groups on the surface of the porous substrate; and
(c) a polymeric coating layer prepared by a controlled radical polymerization process from an aqueous monomer composition comprising at least 50 percent by weight, based on the total weight of monomers in the monomer composition, of at least one (meth)acrylamide monomer having at least one ionic functional group, and wherein the polymeric coating layer is chemically bonded to and propagated from the polymerization initiator (b); and
wherein the polymeric coating layer demonstrates a water contact angle less than 10°, and wherein said separation membrane retains a water contact angle of less than 10° after immersion in phosphate buffered aqueous saline solution at 22° C. for a period of 28 days.

16. A method of separating an aqueous fluid stream, comprising:
(i) contacting the aqueous fluid stream with a separation filter or membrane; and
(ii) allowing water in the fluid stream to permeate through the separation filter or membrane to yield an aqueous product stream, wherein the separation filter or membrane comprises:
(a) a porous substrate with a surface having reactive functional groups;
(b) a radical polymerization initiator chemically bonded to at least one surface of the porous substrate via reaction with the reactive functional groups on the surface of the porous substrate; and
(c) a polymeric coating layer prepared by a radical polymerization process from an aqueous monomer composition comprising at least one free radical polymerizable monomer having at least one hydrophilic functional group, and wherein the polymeric coating layer is chemically bonded to and propagated from the polymerization initiator (b); and
wherein the polymeric coating layer demonstrates hydrophilicity.

17. The method of claim 16, wherein the aqueous fluid stream comprises blood, a wastewater stream from food or beverage production, municipal sewage, pharmaceutical production process water, or poultry processing plant effluent.

18. The method of claim 16, wherein the aqueous fluid stream is contacted with the separation filter or membrane in an end-flow configuration.

19. The method of claim 16, wherein the aqueous fluid stream is contacted with the separation filter or membrane by flowing parallel to the separation filter or membrane in a cross-flow configuration.

20. The method of claim 16, wherein the polymeric coating layer comprises a homopolymer or copolymer of monomers selected from a styrene functional monomer, acrylonitrile, 4-vinylpyridine, sodium 4-vinylbenzenesulfonate, a monomer that is quaternized with a halide or has functional groups that are capable of being quaternized with a halide after polymerization, a (meth)acrylamide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide or salts thereof, and 3-[(3-(meth)acrylamidopropyl)dimethylammonio]propanoate.
